(19) United States
(12) Patent Application Publication
(10) Pub. No.: US 2023/0196314 A1
(43) Pub. Date: Jun. 22, 2023

(54) FUNDS TRANSFER SERVICE METHODS AND SYSTEMS FOR FACILITATING FUNDS TRANSFERS

(71) Applicant: Mastercard International Incorporated, Purchase, NY (US)

(72) Inventor: Sowmya Reddy Lakka, Wildwood, MO (US)

(21) Appl. No.: 18/080,020

(22) Filed: Dec. 13, 2022

Related U.S. Application Data
(60) Provisional application No. 63/290,113, filed on Dec. 16, 2021.

(51) Int. Cl. G06Q 20/10; G06Q 20/40; G06Q 20/38

(52) U.S. Cl. CPC G06Q 20/10; G06Q 20/4014; G06Q 20/3821; G06Q 2220/00

(57) ABSTRACT

A payments transfer service method for facilitating a funds transfer between a sender and a recipient. In an embodiment, a payment processing network receives a funding transaction request message comprising a transaction amount and a Pre-Payment Transaction (Pre-PT) message from an originating institution (OI) computer, determines an issuer financial institution (FI) that issued a payment account to the sender and transmits the funding request message and the Pre-PT message to an issuer FI computer of the issuer FI. The method also includes the payment processing network receiving a funding authorization message from the issuer FI computer, transmitting the funding authorization message to the OI computer, receiving a payment transaction request from one of the OI computer and a transaction initiator computer, and transmitting the funding authorization message to the RI computer.

### CROSS-REFERENCE TO RELATED APPLICATION

This application claims the benefit of U.S. Provisional Patent Application No. 63/290,113 filed on Dec. 16, 2021, the contents of which are hereby incorporated by reference for all purposes.

### FIELD OF THE INVENTION

Methods and systems for implementing a funds transfer service to facilitate funds transfers, including domestic and cross-border funds transfers, between a sender and a recipient. More specifically, disclosed are funds transfer service methods and systems that include a pre-processing transaction (Pre-PT) message and/or a post-processing transaction (Post-PT) message including information necessary to facilitate a sender's funds transfer request of a transaction amount from a financial account of the sender to a recipient's financial account.

### BACKGROUND

Electronic money transfer or electronic funds transfer (EFT) has been widely available for years. For example, a sender visits his or her bank or uses the bank's web interface to request that the bank wire a certain amount of money to a receiver, wherein the receiver may be located in the same country or in a foreign country. However, conventional EFT requests require both the sender and the receiver to have bank accounts at banks that support domestic and/or international electronic funds transfers, and such money transfers can be expensive and time consuming. In addition, many banks in rural areas of underdeveloped countries are unlikely to provide an international EFT service that efficiently and conveniently transfers funds especially when it comes to transferring money internationally and/or otherwise entering into a cross-border transaction. Accordingly, senders of funds continue to search for a secure, inexpensive and quick process for sending funds to a third party in another country.

Currently, there are no easy to use and inexpensive methods available for transferring funds from a sender to a recipient in a foreign country. This may be because there are various challenges that need to be overcome when it comes to managing funds transfer payments, especially cross-border payments. For example, certain additional details (as compared to the details needed for a “domestic transfer” to transfer money between a sender and recipient located in or resident in the same country) are typically required by a sending financial institution (“FI” such as a sending bank) and/or by a receiving FI in order to process cross-border money transfer payments, for example to a bank account owned by the receiver in the receiving FI (e.g., a foreign bank). Such additional details may include information such as a government identifier (ID), passport data, and perhaps other details and/or information required by the receiving FI which relate to the sender and/or to the recipient. Moreover, in some cases current and correct cardholder billing currency information must be made available so that the sender of the funds has a clear idea of exactly how much money will be transferred to the recipient's account. In addition, in order to provide a best user experience, it would be beneficial for the status of previously processed cross-border transactions between the sender and recipient be made available and/or be provided to the sending FI. Moreover, it would be beneficial for both the sender and recipient to be provided with an estimate of the date and/or the time when the funds will be posted to the recipient's financial account and/or when the funds will be available for use by the recipient.

Thus, it would be desirable to provide a funds transfer service that facilitates and/or enhances funds transfers from a sender to a recipient, and that solves the problems described above concerning providing required information in order for a sender FI to process such a transfer of funds.

### BRIEF DESCRIPTION OF THE DRAWINGS

Features and advantages of some embodiments of the present disclosure, and the manner in which the same are accomplished, will become more readily apparent upon consideration of the following detailed description taken in conjunction with the accompanying drawings, which illustrate preferred and example embodiments and which are not necessarily drawn to scale, wherein:

FIG. 1 is a block diagram of a system for enabling electronic funds transfers involving payment accounts of a sender and of a recipient in accordance with some embodiments of the disclosure;

FIG. 2 is a functional block diagram illustrating a method for utilizing Pre-Processing Transaction messages and Post-Processing Transaction messages in accordance with some embodiments of the disclosure;

FIGS. 3A and 3B illustrate lists of payment information request data and payment information response data in accordance with embodiments of the disclosure;

FIG. 4 is a block diagram of a payment processor computer in accordance with some embodiments of the disclosure; and

FIG. 5 is a flow diagram of an electronic funds transfer process between a sender account and a recipient account in accordance with embodiments of the disclosure.

### DETAILED DESCRIPTION

Reference will now be made in detail to various novel embodiments, examples of which are illustrated in the accompanying drawings. The drawings and descriptions thereof are not intended to limit the invention to any particular embodiment(s). On the contrary, the descriptions provided herein are intended to cover alternatives, modifications, and equivalents thereof. In the following description, numerous specific details are set forth in order to provide a thorough understanding of the various embodiments, but some or all of the embodiments may be practiced without some or all of the specific details. In other instances, well-known process operations have not been described in detail in order not to unnecessarily obscure novel aspects.

A number of terms will be used herein. The use of such terms are not intended to be limiting, but rather are used for convenience and ease of exposition. For example, as used herein, the term “cardholder” may be used interchangeably with the term “consumer” and/or with the term “user” and these terms are used herein to refer to a person, individual, consumer, business or other organization that owns (or is authorized to use) a financial account such as a bank account or a payment card account (for example, a credit card account or a debit card account) or some other type of financial account. The term “payment card account” may include a credit card account, a debit card account, a loyalty card account and/or a deposit account or other type of financial account that an account holder or cardholder may access. The term “payment card account number” includes a number that identifies a payment card account or a number carried by a payment card, and/or a number that is used to route a transaction in a payment card processing system that handles credit card and/or debit card transactions and the like.

In addition, as used herein the terms “payments processor network” and/or “payment network” and/or “payment card processing network” and/or “payment card processing system” and/or “payment card system” refer to a system and/or network for processing and/or handling domestic funds transfers and/or foreign funds transfers and/or cross-border funds transfers and/or related transactions and/or purchase transactions, which may be operated by a payment card system operator such as Mastercard International Incorporated, or a similar system. In some embodiments, the term “payment card system” or “payment network” may be limited to systems in which member financial institutions (such as banks) issue payment card accounts to individuals, businesses and/or other entities or organizations (and thus are known as issuer financial institutions (FIs) or issuer banks). In addition, the terms “payment system transaction data” and/or “payment network transaction data” or “payment card transaction data” or “payment card network transaction data” refer to transaction data associated with payment transactions or purchase transactions that have been or are being processed over and/or by a payment network or payment system or payment processing network. For example, payment system transaction data may include a number of data records associated with individual payment transactions (or purchase transactions) of one or more cardholders that have been processed over a payment card system or payment card network or payment processing network.

In some embodiments, payment system transaction data and/or payments processor network transaction data may include information such as data that identifies a cardholder, data that identifies a cardholder's payment device, data that identifies the cardholder's payment card account, transaction date and time data, transaction amount data, an indication of the merchandise and/or services that have been purchased, information identifying a recipient of a funds transfer, data indicative of funds transfer amount(s), data indicative of a time and/or date of a funds transfer, data indicative of a reason or reasons why the sender is transmitting funds to a recipient (which in embodiments disclosed herein may be another cardholder), and/or information identifying a merchant and/or a merchant category and/or data identifying a recipient and/or identifying a recipient financial account. Additional transaction details and/or transaction data may also be available and/or utilized for various purposes in some embodiments.

In general, and for the purposes of introducing concepts of embodiments of the present disclosure, disclosed herein are funds transfer service methods and systems for facilitating domestic, cross-border and/or international payments from a sender (for example, a cardholder and/or consumer, and/or a business) having a sending account to a recipient (for example, another cardholder and/or consumer, and/or another business) having a receiving account. In disclosed embodiments, a pre-processing transaction (Pre-PT) message and/or a post-processing transaction (Post-PT) message are used to facilitate a funds transfer between a sender account and a recipient account. In particular, the Pre-PT message and the Post-PT message includes information or data that may be necessary and/or required to conduct or facilitate a domestic funds transfer and/or a cross-border funds transfer (which may be a foreign funds transfer) of a transaction amount from a sender having an account, for example at an issuer financial institution (FI), to a recipient having an account at the same or at a different, receiving FI (such as a bank). Thus, in some embodiments the issuer FI may be the same as the receiving FI. In addition, embodiments of the funds transfer service may permit person-to-person, person-to-merchant (or business), merchant (or business)-to-person, or business-to-business funds transfers.

In some embodiments, the Pre-PT message may include a quote for a foreign exchange (FX) conversion rate. The foreign exchange (FX) conversion rate may include a validity period (for example, the validity period may be for a somewhat short period of time, such as sixty minutes, or may be another time frame corresponding to an accepted window of time wherein the conversion rate is valid). In some implementations, the validity period is a window of time (or a time frame) that has been approved by an official organization, such as an official Treasury Department (or other government agency) of the country within which the recipient resides. In some implementations, Pre-PT messages may include a request for additional information to be provided by the receiving issuer (RI), for example, a request for a government identifier (ID), passport information and the like data for use to process a payment to their account holders, for use to share information related to the recipient, for cardholder billing currency information from the RI, and for the posting amount to the recipient account by the RI, and the like.

In addition, in some implementations Post-PT message processing may include sharing certain data with the RI so that the RI can conduct sanctions checks and anti-money laundering (AML) checks before the RI processes the authorization for a cross-border funds transfer. Post-PT messages may also facilitate checking the post time of the funds by the RI to the recipient account, and may facilitate a status check for previously processed transactions involving the recipient to the RI.

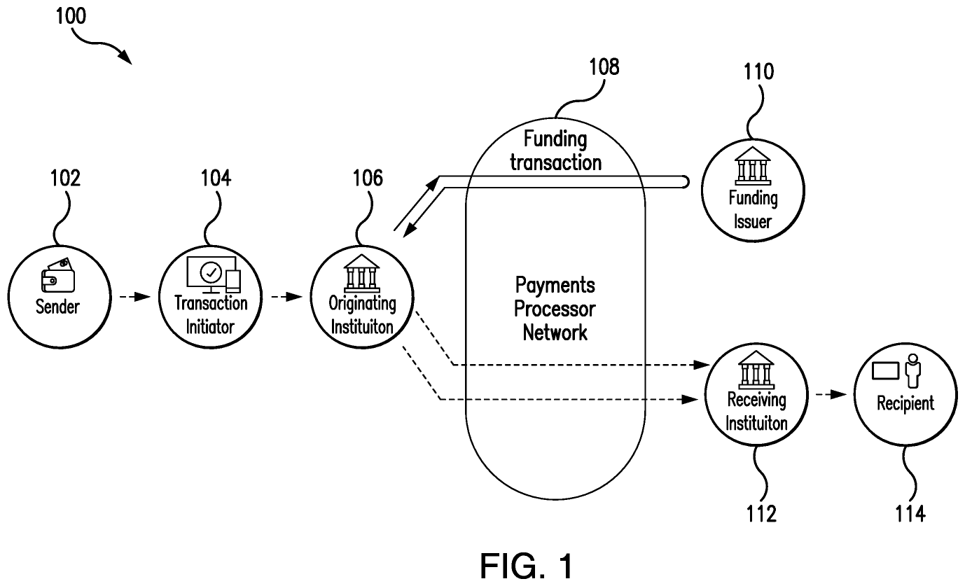

FIG. 1 is a block diagram of a system 100 for enabling domestic and cross-border funds transfers involving payment accounts in accordance with embodiments of the present disclosure. The system 100 includes a sender 102 who has a payment account, a transaction initiator 104, an originating institution 106, a payments processor network 108, a funding issuer 110, a receiving institution 112, and a recipient 114 who also has a payment account to receive funds. In addition, in some embodiments the transaction initiator 104, the originating institution 106, the funding issuer 110, the receiving institution 112, and the recipient 114 are all registered for a cross-border transaction service with the payments processor network 108.

Each block in FIG. 1 represents an entity and/or a computer and should also be understood to represent one or more computers and/or networks operated by or on behalf of that entity. In addition, the system 100 illustrated in FIG. 1 is presented in the context of illustrating a domestic and/or a cross-border and/or international funds transfer for one sender having a payment account (including sender information and/or sender credentials) and one recipient having a payment account for ease of reference. However, it should be understood that a practical embodiment of the system 100 may be configured to handle a plurality of domestic or cross-border funds transfers involving a plurality of senders and a plurality of recipients associated with a plurality of financial accounts (such as cardholder accounts), including numerous simultaneous funds transfer requests. Thus, the system 100 may include additional entities and/or computers and/or computer networks and/or computing resources or components (such as servers and/or cloud computing devices and/or components) that also perform at least some of the roles performed by the entities, devices, components and/or computers shown explicitly in FIG. 1.

Referring again to the example embodiment of FIG. 1, the transaction initiator 104 is the program provider, such as a money transfer operator (MTO) which is a financial company (but typically not a bank) that engages in funds transfers. The MTO 104 interacts with the sender 102 and the originating institution 106 (which in some cases is the sender's bank) to initiate the processing of the transaction. For example, in some embodiments the transaction initiator or MTO 104 receives an order from the sender 102 for a funds transfer to a recipient 114, which order includes payment transaction information such as the amount of the funds transfer, recipient identification information, and sender payment card account information along with additional sender information and/or data. The originating institution 106, which is a financial institution (FI) such as a bank, receives the funds transfer request from the transaction initiator 104, and determines whether or not the sender holds a payment card account with the originating institution.

Next, referring to FIG. 1, if the sender does not have a payment card account with the originating institution 106, then the originating institution 106 transmits a funding transaction request (which is a pull request, to obtain funds to cover the funds transaction) to the payment processor network 108, which may be owned and/or operated by a payments processing entity or payments processor such as Mastercard International Incorporated, the assignee of the present application. For example, the originating institution 106 may connect to the payment processing network 108 operated by Mastercard International Incorporated by using International Organization for Standardization (ISO) payment network messages via a payment network processor such as the Mastercard Interface Processor (MIP) or by using an application program interface (API) (not shown).

The payment processor network 108 then identifies or determines the issuer financial institution (FI) or funding issuer 110 that issued the sender's payment card account and transmits a funding request message to the funding issuer FI 110. The funding request message may include cardholder identification data, the transaction amount and other data. In some implementations, more than one form of cardholder identification data may be required by the funding issuer FI 110 to authenticate the sender, which is beyond the scope of the present application and thus will not be discussed in detail herein. In the case where the sender is authenticated, the funding issuer 110 then checks the sender's payment card account to ensure that the account has an adequate amount of funds or credit available to cover the total cost of the funds transfer. After the funding issuer FI 110 determines that the sender's payment card account has adequate funds (or adequate credit) available to cover the costs of the funds transfer, via an authorization message known as a “funding authorization” message (or other forms), then the transaction initiator of MTO 104 (the program provider) or the originating institution 106 will initiate a payment transaction with the payments processor network 108. The payments processor network 108 then transmits the payment authorization message to the receiving institution (RI) 112. Upon approval of the payment authorization message the RI then posts funds in the transfer amount to the recipient's account (for example, a payment card account owned by the recipient).

In accordance with embodiments disclosed herein, a Pre-Processing Transaction message (Pre-PT message) is initiated before invoking the actual transfer of funds as explained above. The Pre-PT message is utilized by the transaction initiator or MTO 104 or by the originating institution 106 to validate the data provided by the sender 102. The Pre-PT message facilitates validation of the data and/or causes the transaction initiator 104 or the originating institution 106 to collect any missing data prior to initiating a funds transfer. For example, missing data may include, but is not limited to, the sender's full name, sender account credentials, and the sender's residence address (which may also be the sender's billing address, which information must match the address information on file at the sender's issuer bank). In addition, with regard to cross-border transactions, the Pre-PT message facilitates obtaining additional information or data, for example a quote for a foreign exchange (FX) conversion rate between the sender's currency and the recipient's currency. As mentioned above, the quote for such an FX conversion rate may be valid for only a limited time, for example, valid for sixty (60) minutes. In addition, the Pre-PT message may be used to facilitate obtaining any additional recipient data that may be required from the receiving institution 112 to process and accept a payment transaction, such as a Government Identifier (ID), Passport data and/or other identification data which may need to be verified, cardholder billing currency, and the posting amount that will be posted to the recipient account.

In contrast, in embodiments disclosed herein the Post-Processing Transaction message (Post-PT message) is initiated after invoking the actual transfer of funds. The Post-PT message may be utilized to, for example, check the posting time to the recipient account (when funds will appear in the recipient's account), and to conduct a status check concerning previous processed transaction(s) between the sender and the recipient. In some embodiments, the Post-PT message may also be initiated by the transaction initiator or MTO 104 or by the originating institution 106 via the payments processor network 108 to receive the status of a previously processed transfer to the sender 102 from the receiving institution (RI) 112.

With reference again to FIG. 1, in some implementations the payments processor network 108 transmits the Pre-PT messages and/or the Post-PT messages to the Funding Issuer 110 and/or to the receiving institution (RI) 112, which may be the issuer of the sender's 102 payment account or the issuer of the recipient's 114 payment account, for further processing. Upon receipt of the Pre-PT message, the sending or funding issuer 110 or the RI 112 validates the data, such as the sender's billing address, full name of the sender 102 or full name of the recipient 114 (which were either provided or have been added during processing). For example, Pre-PT messaging may include adding required missing information such as the billing currency of the receiver. In addition, the RI 112 may provide required additional data to accept a transfer.

Referring again to FIG. 1, in the case where the sender's payment account is held by the originating FI 106, then the originating FI is also the funding issuer. In this situation, the originating FI 106 may perform cardholder authentication and payment card account processing in order to authenticate the cardholder and to ensure that the cardholder's payment card account has adequate funds (or enough available credit) to cover the costs involved with the domestic or cross-border money transfer. The originating FI 106 may also communicate with the receiving institution 112 via the payment processor network 108 to obtain recipient data and/or information needed for the transfer of funds or to check status of a processed transfer.

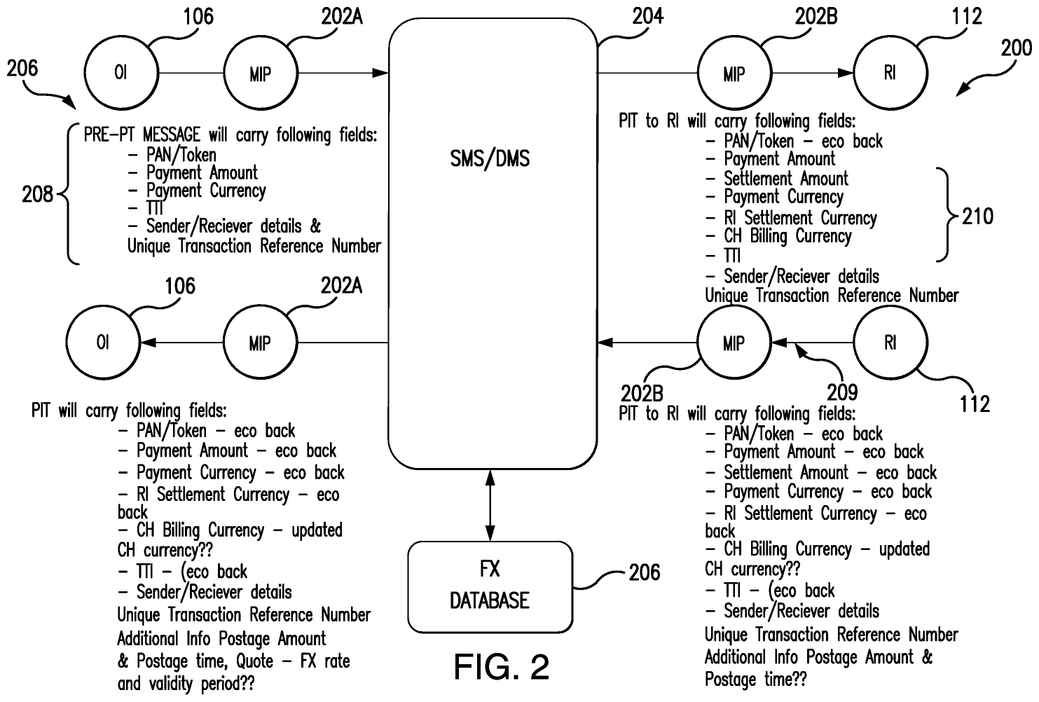

FIG. 2 is a functional block diagram 200 illustrating a method and an option for generating a Pre-PT message and/or a Post-PT message in accordance with some embodiments. As explained above, the Pre-PT message and the Post-PT message are information messages that enhance an account status inquiry (ASI) service (not shown) and/or that enhance an address verification service (AVS) (not shown). The Pre-PT and Post-PT messages may include information or data necessary for a transaction, such as a quote for a foreign exchange (FX) conversion rate between the sender's currency and the recipient's currency (which is valid for a specific length of time), additional data from the sending institution 110 or receiving institution 112 relating to the recipient such as a

Government Identifier (ID), a Passport, and/or other identifying data, cardholder billing currency, the posting amount to the recipient account, the posting time to the recipient account (when funds will appear in the recipient's account), and a status check for previous processed transaction(s) between the sender and the recipient. In some implementations, the originating institution 106 initiates the processing of the Pre-PT message prior to processing a transfer of funds.

Referring to FIG. 2, in some embodiments the originating institution 106 communicates with a single message system (SMS) platform or dual messaging system (DMS) platform, such as the SMS/DMS platform 204 as shown, via a Mastercard Information Processor (MIP) 202A or through other support channels. The SMS/DMS platform 204 is operably connected to a foreign conversion rate (“FX”) database 206 which stores current foreign currency exchange rate data (FX data). In some embodiments, the FX database 206 is updated with current conversion rates between various currencies at predetermined time intervals during the day by a remote computer (not shown). In some implementations, the up-to-date conversion rates may be provided by payment network treasury systems located in the same country as the recipient 114 or in the same country as the receiving institution 112.

As shown in FIG. 2, a Pre-PT message 206 from the originating institution 106 has fields 208 that include a PAN/Token, a payment amount, the payment currency, and a transaction type identified (TTI), wherein the TTI indicates whether the transfer of funds is a person-to-person transfer or a person-to-merchant transfer, and the like. The fields 208 may also include sender and/or receiver details and a unique transaction reference number. The Pre-PT message is transmitted via MIP 202A and SMS/DMS 204 and MIPS 202B to the receiving institution 112 and includes the same information (within fields 208) as the Pre-PT message from the originating institution 106, and additionally includes fields 210 with additional information such as a settlement amount, a payment currency, receiving institution settlement currency and a cardholder (CH) billing currency. The receiving institution 112 then processes the payment transaction request and transmits 209 a Post-PT message via the MIP 202C and SMS/DMS 204 and the MIP 202D to the OI 106 that echoes back the same fields mentioned immediately above, and in addition updates the CH billing currency field and adds additional information such as the amount that will be posted to the recipient's payment account, an estimate of a time when that posting will occur, and in some implementations a unique transaction reference number.

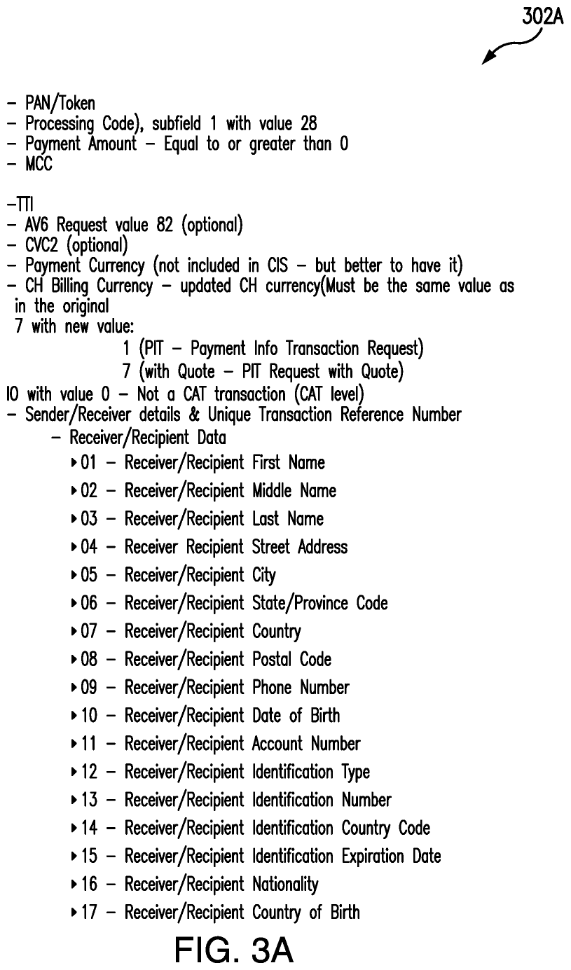

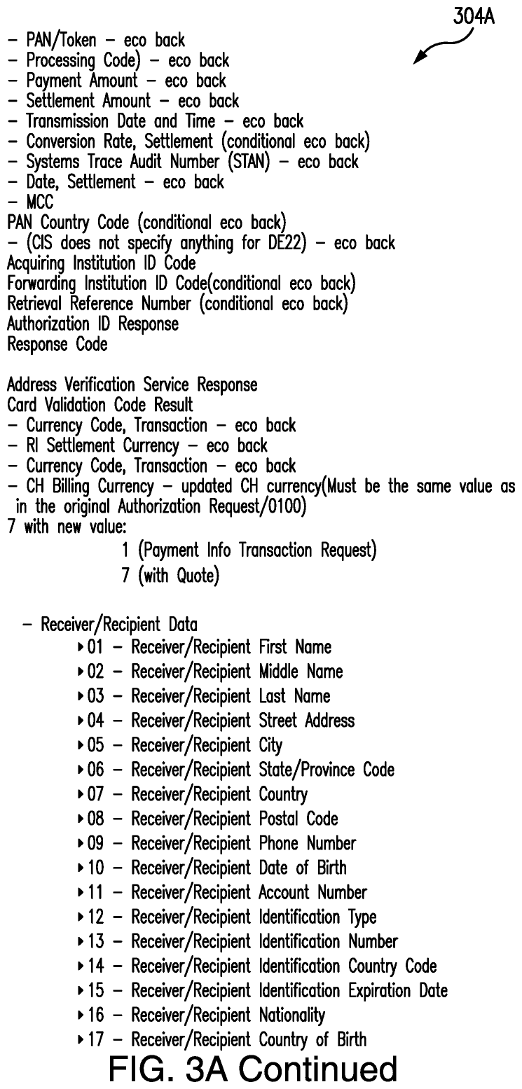

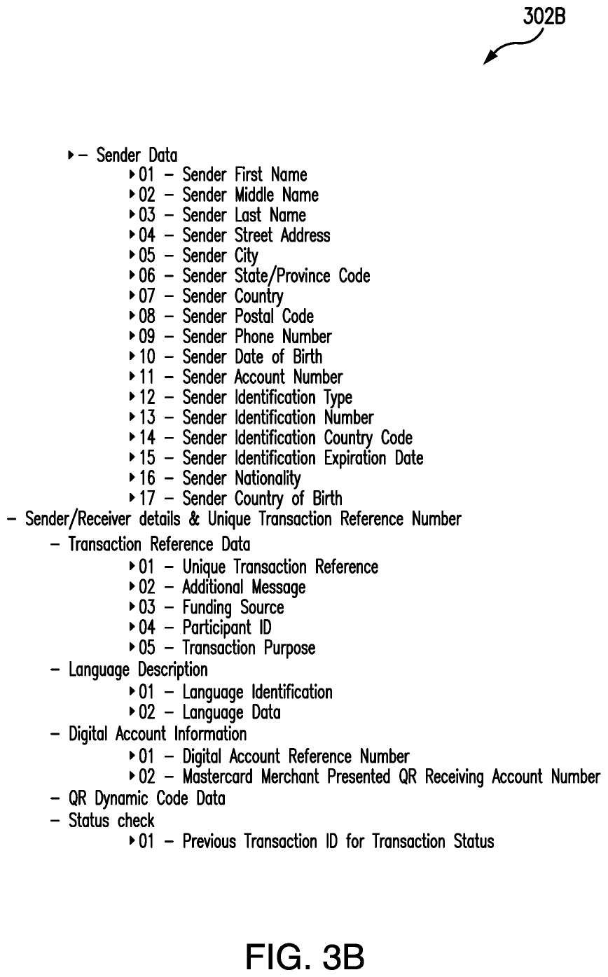

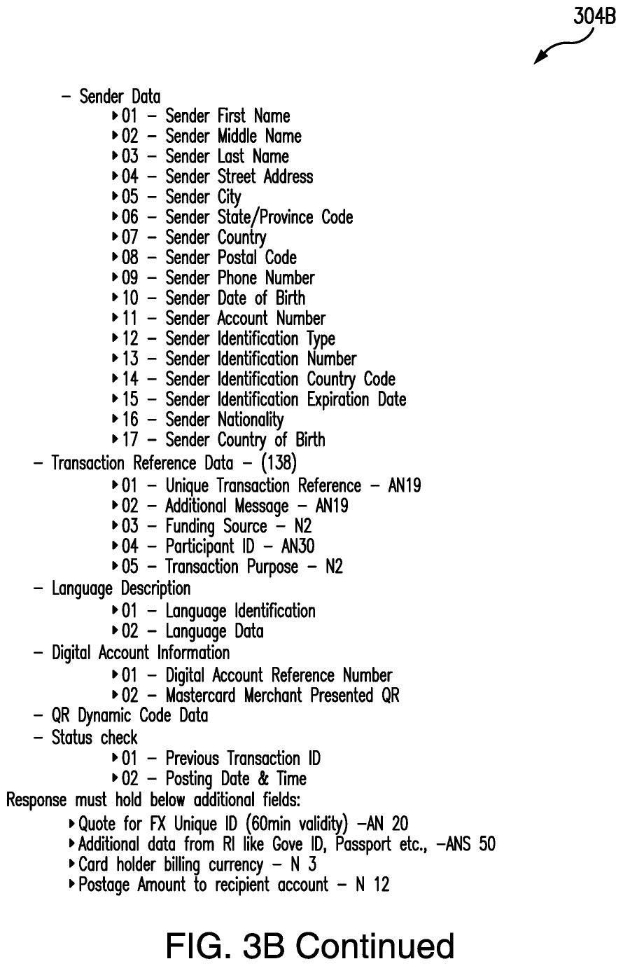

FIGS. 3A and 3B illustrate examples of lists of payment information request data 302A, 302B and associated payment information response data 304A, 304B in accordance with some embodiments.

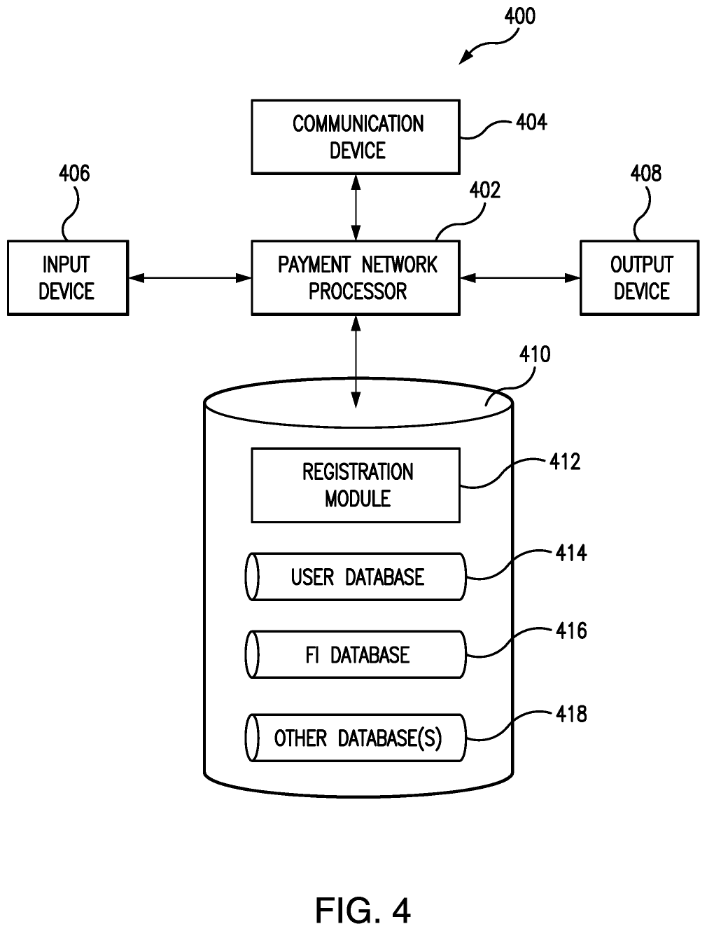

FIG. 4 is a block diagram of a payment processor network computer 400 according to an embodiment. The payment processor network computer 400 may be controlled by software to cause it to operate in accordance with aspects of the methods presented herein concerning cross-border payment transactions. In particular, the payment processor network computer 400 may include a payment network processor 402 operatively coupled to a communication device 404, an input device 406, an output device 408, and a storage device 410. However, it should be understood that, in some embodiments the payment processor network computer 400 may include several computers or a plurality of server computers that work together as part of a system to facilitate domestic and cross-border payment transactions. In such a system, different portions of the overall method for facilitating transactions between a sender and a recipient may be provided by one or more computers in communication with one or more other computers such that an appropriate scaling up of computer availability may be provided if and/or when greater workloads, for example a large number of senders request cross-border payments, are encountered.

The payment network processor 402 may constitute one or more processors, which may be special-purpose processor(s), that operate to execute processor-executable steps contained in non-transitory program instructions described herein, such that the payment network processor 402 provides desired functionality.

Communication device 404 may be used to facilitate communication with, for example, electronic devices such as originating institution computers, funding issuer computers and recipient institution computers. The communication device 404 may, for example, have capabilities for engaging in data communication over the Internet, over different types of computer-to-computer data networks, and/or may have wireless communications capability. Any such data communication may be in digital form and/or in analog form.

Input device 406 may comprise one or more of any type of peripheral device typically used to input data into a computer. For example, the input device 406 may include a keyboard, a computer mouse and/or a touchpad or touch screen. Output device 408 may comprise, for example, a display screen and/or a printer.

Storage device 410 may include any appropriate information storage device, storage component, and/or non-transitory computer-readable medium, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices, as well as flash memory devices. Any one or more of the listed storage devices may be referred to as a “memory”, “storage” or a “storage medium.”

Thus, it should be understood that the term “computer-readable medium” as used herein refers to any non-transitory storage medium that participates in providing data (for example, computer executable instructions or processor executable instructions) that may be read by a computer, a processor or a like device. Such a medium may take many forms, including but not limited to, non-volatile media and volatile media. Non-volatile media may include, for example, optical or magnetic disks and other persistent memory. Volatile media may include dynamic random access memory (DRAM), which typically constitutes the main memory. Common forms of computer-readable media include, for example, a floppy disk, a flexible disk, hard disk, magnetic tape, a solid state drive (SSD), any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Various forms of computer readable media may be involved in providing sequences of computer processor-executable instructions to a processor. For example, sequences of instruction (i) may be delivered from RAM to a processor, (ii) may be wirelessly transmitted, and/or (iii) may be formatted according to numerous formats, standards or protocols, such as Transmission Control Protocol, Internet Protocol (TCP/IP), Wi-Fi, Bluetooth, TDMA, CDMA, and 3G.

Referring again to FIG. 4, storage device 410 stores one or more programs for controlling the processor 402. The programs comprise program instructions that contain processor-executable process steps of the payment processor network computer 400, including, in some cases, process steps that constitute processes provided in accordance with principles of the processes disclosed herein. The programs may include a Pre-payment transaction (Pre-PT) message API and a Post-payment transaction (Post-PT) message API which can manage processes that generate and/or provide data and/or information to a receiving institution and/or to an originating institution to facilitate domestic and/or cross-border and/or international funds transactions.

The storage device may also include a registration module 412 for use by senders, recipients, originating institutions, issuer FIs, and receiving institutions to register themselves with the payment processor network computer 400 for conducting funds transactions as described herein, which may include domestic transaction service and a cross-border transaction service permitting transactions between senders and recipients who are, for example, cardholders. In some embodiments, the registration process may allow such parties or entities to register for transaction services by accessing, for example via their computer, mobile telephone or tablet computer (not shown), a suitable web page hosted by the payment processor network computer 400. The information gathered during the registration process may include, for example, issuer FI identifier(s) and/or recipient FI identifier(s) and/or bank identification (BIN) numbers and/or BIN ranges, sender information, recipient information, and the like information and/or data.

The storage device 410 may also include a user database 414 which stores registered users (both senders and recipients), and a financial institution database 416 including computer executable instructions for controlling the payment processor network computer 400 to process data and/or information to make domestic and cross-border funds transfers or payments possible. The storage device 410 may also include one or more other database(s) 418 and/or have connectivity to other databases (not shown) which may be required for operating the payment processor network computer 400.

Application programs and/or computer readable instructions run by the payment processor network computer 400, as described above, may be combined in some embodiments, as convenient, into one, two or more application programs. Moreover, the storage device 410 may store other programs or applications, such as one or more operating systems, device drivers, database management software, web hosting software, and the like.

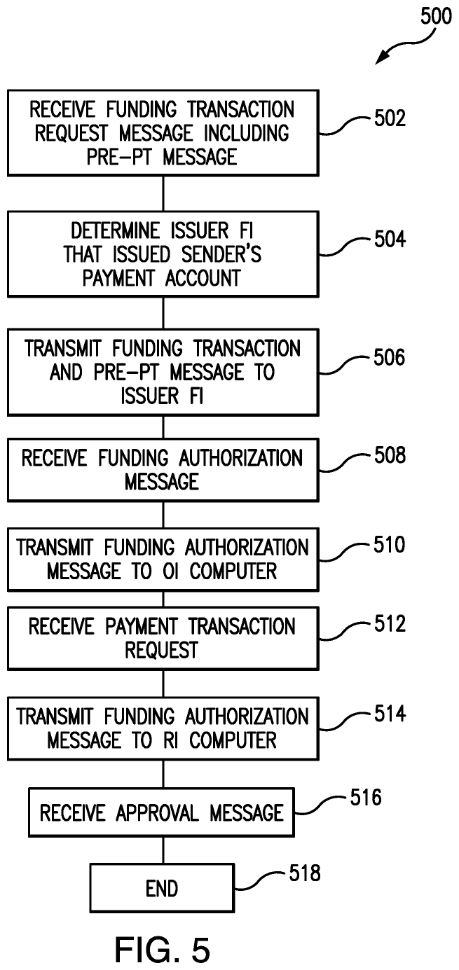

FIG. 5 is a flow diagram 500 of an electronic funds transfer process that facilitates the transfer of funds between a sender account and a recipient account in accordance with some embodiments. A payment processing network receives 502 a funding transaction request message from an originating institution (OI) computer, wherein the funding transaction request message includes a transaction amount and a Pre-Payment Transaction (Pre-PT) message. The Pre-PT message includes recipient information including receiving institution (RI) computer identification data. In some implementations, the Pre-PT message is generated by one of a transaction initiator computer (or MTO computer) and an OI computer. The payment processing network next determines 504 the issuer financial institution (FI) that issued a payment account to the sender, and then transmits 506 the funding request message and the Pre-PT message to an issuer FI computer of the issuer FI. The process continues with the payment processing network receiving 508 a funding authorization message from the issuer FI computer, transmitting 510 the funding authorization message to the OI computer, then receiving 512 a payment transaction request from one of the OI computer and a transaction initiator computer. The payment processing network then transmits 514 the funding authorization message to the receiving institution (RI) computer. In some implementations, the payment processing network next receives 516 an approval message indicating approval of the funds transfer from the receiving institution computer, and the process ends 518.

In some implementations, prior to receiving the funding transaction request message 502, the payment processing network receives at least one payment network message from a payment network processor, such as the Mastercard Interface Processor (MIP), wherein the at least one payment network message is in accordance with International Organization for Standardization (ISO) payment network messages. In other implementations, prior to receiving the funding transaction request message 502 the payment processing network receives at least one payment network message via an application program interface (API), wherein the at least one payment network message is in accordance with International Organization for Standardization (ISO) payment network messages.

In some embodiments, the payments transfer service method illustrated by FIG. 5 may also include the payment processing network receiving a Post-Processing Transaction (Post-PT) message from the receiving FI computer (not shown. In such an implementation, the payment processing network then transmits the Post-PT message to at least one of the issuer computer and the OI computer, wherein the Post-PT message may include at least one of a posting time, a posting amount of the funds transfer to the recipient account, and status check data concerning previous processed transaction(s) between the sender and the recipient.

In implementations of the payments transfer service method shown in FIG. 5, the Pre-PT message may include at least two of the sender's full name, sender account credentials, the sender's residence address, the recipient's full name, a Government identifier (ID), passport data, cardholder billing currency, and a posting amount that will be posted to the recipient account. In some embodiments of the payments transfer service method the sender is in a first country and the recipient is in one of the same country or a foreign country. Accordingly, in some implementations the funding request message is a cross-border funding request message that includes cardholder identification data and a cross-border transaction amount. In addition, the funding request message may also include cardholder identification data.

Accordingly, the funds transfer methods and systems disclosed herein provide an easy to use, inexpensive and secure process for transferring funds from a sender to a recipient either domestically or internationally (to a recipient account in a foreign country). Moreover, the disclosed funds transfer methods and systems advantageously leverage existing payment processing networks and infrastructure to securely and quickly facilitate such payment transactions between the senders and the recipients who have payment accounts, which may include person-to-person, person-to-merchant (or business), merchant (or business)-to-person, or business-to-business payment transactions.

In embodiments, the Pre-PT message and Post-PT message allows consumers or cardholders, and businesses, to easily, seamlessly and securely transfer money domestically, internationally (such as cross-borders) to recipients such that the funds are immediately available, or available within a short amount of time (for example, within 30 minutes). Specifically, Pre-PT and Post-PT messages are provided that include details needed for a “domestic transfer” to transfer money between a sender and recipient located in or resident in the same country) that are typically required by a sending financial institution (FI) and/or by a receiving FI in order to process a cross-border money transfer payment (for example, a transfer to a foreign bank account owned by the receiver). Moreover, in some cases current and correct cardholder billing currency information must be made available so that the sender of the funds has a clear idea of exactly how much money will be transferred to the recipient's account. Some implementations also permit a best user experience to be achieved by providing the status of previously processed cross-border transactions between the sender and recipient to the sending FI, which may speed up authorization of such a transfer. Moreover, in some implementations both the sender and recipient can beneficially be provided with an estimate of the date and/or the time when the funds will be posted to the recipient's financial account and/or when the funds will be available for use by the recipient. Furthermore, since the disclosed processes leverage on existing payment processing network infrastructure, funds transfers or payments are seamless with regard to the operations and technology for senders, program providers, receiving institutions and recipients.

As used herein, the term “computer” should be understood to encompass a single computer or two or more computers in communication with each other.

As used herein, the term “processor” should be understood to encompass a single processor or two or more processors in communication with each other.

As used herein, the term “memory” should be understood to encompass a single memory or storage device or two or more memories or storage devices.

As used herein, a “server” includes a computer device or system that responds to numerous requests for service from other devices.

The above descriptions and illustrations of processes herein should not be considered to imply a fixed order for performing the process steps. Rather, the process steps may be performed in any order that is practicable, including simultaneous performance of at least some steps and/or omission of steps.

Although the present disclosure has been described in connection with specific example embodiments, it should be understood that various changes, substitutions, and alterations apparent to those skilled in the art can be made to the disclosed embodiments without departing from the spirit and scope of the disclosure.

What is claimed is:

1. A payments transfer service method for facilitating a funds transfer between a sender and a recipient comprising:
receiving, by a payment processing network from an originating institution (OI) computer, a funding transaction request message comprising a transaction amount and a Pre-Payment Transaction (Pre-PT) message, wherein the Pre-PT message comprises recipient information including receiving institution (RI) computer identification data;
determining, by the payment processor network, an issuer financial institution (FI) that issued a payment account to the sender;
transmitting, by the payment processing network to an issuer FI computer of the issuer FI, the funding request message and the Pre-PT message;
receiving, by the payment processing network from the issuer FI computer, a funding authorization message;
transmitting, by the payment processing network to the OI computer, the funding authorization message;
receiving, by the payment processing network from one of the OI computer and a transaction initiator computer, a payment transaction request; and
transmitting, by the payment processing network to the RI computer, the funding authorization message.

2. The payments transfer service method of claim 1, further comprising receiving, by the payment processing network from the RI computer, an approval message indicating approval of the funds transfer.

3. The payments transfer service method of claim 1, further comprising, prior to receiving the funding transaction request message:
receiving, by the payment processing network, at least one payment network message from a payment network processor, wherein the at least one payment network message is in accordance with International Organization for Standardization (ISO) payment network messages.

4. The payments transfer service method of claim 1, further comprising, prior to receiving the funding transaction request message:
receiving, by the payment processing network, at least one payment network message via an application program interface (API), wherein the at least one payment network message is in accordance with International Organization for Standardization (ISO) payment network messages.

5. The payments transfer service method of claim 1, further comprising:
receiving, by the payment processing network from the receiving FI computer, a Post-Processing Transaction (Post-PT) message; and
transmitting, by the payment processing network to at least one of the issuer computer and the OI computer, the Post-PT message.

6. The payments transfer service method of claim 5, wherein the Post-PT message comprises at least one of a posting time, a posting amount of the funds transfer to the recipient account, and status check data concerning previous processed transaction(s) between the sender and the recipient.

7. The payments transfer service method of claim 1, wherein the Pre-PT message comprises at least two of the sender's full name, sender account credentials, the sender's residence address, the recipient's full name, a Government identifier (ID), passport data, cardholder billing currency, and a posting amount that will be posted to the recipient account.

8. The payments transfer service method of claim 1, wherein the sender is in a first country and the recipient is in one of the same country or a foreign country.

9. The payments transfer service method of claim 8, wherein the funding request message is a cross-border funding request message comprising cardholder identification data and a cross-border transaction amount.

10. The payments transfer service method of claim 1, wherein the funding request message further comprises cardholder identification data.

11. A payments transfer service system for facilitating a funds transfer between a sender and a recipient comprising:
a payments processing network comprising a payment network processor, a communication device operably connected to the payment network processor, and a storage device operably connected to the payment network processor;
a plurality of originating institution (OI) computers operably connected to the payments processing network;
a plurality of receiving institution (RI) computers operably connected to the payments processing network; and
a funding institution computer operably connected to the payments processing network;
wherein the storage device includes processor executable instructions which when executed cause the payments network processor to:
receive a funding transaction request message from an OI computer, the funding transaction request message comprising a transaction amount and a Pre-Payment Transaction (Pre-PT) message, wherein the Pre-PT message comprises recipient information including receiving institution (RI) computer identification data;
determine an issuer financial institution (FI) computer of an issuer FI that issued a payment account to the sender;
transmit the funding request message and the Pre-PT message to the issuer FI computer of the issuer FI that issued the sender payment account;
receive a funding authorization message from the issuer FI computer;
transmit the funding authorization message to the OI computer;
receive, from one of the OI computer and a transaction initiator computer, a payment transaction request; and
transmit the funding authorization message to the RI computer.

12. The system of claim 11, wherein the storage device comprises further processor executable instructions which when executed cause the payments network processor to receive an approval message indicating approval of the funds transfer from the RI computer.

13. The system of claim 11, wherein the storage device comprises further processor executable instructions, prior to the instructions for receiving the funding transaction request message, which when executed cause the payments network processor to receive at least one payment network message from a payment network processor, wherein the at least one payment network message is in accordance with International Organization for Standardization (ISO) payment network messages.

14. The system of claim 11, wherein the storage device comprises further processor executable instructions, prior to the instructions for receiving the funding transaction request message, which when executed cause the payments network processor to receive at least one payment network message via an application program interface (API), wherein the at least one payment network message is in accordance with International Organization for Standardization (ISO) payment network messages.

15. The system of claim 11, wherein the storage device comprises further processor executable instructions which when executed cause the payments network processor to:
receive a Post-Processing Transaction (Post-PT) message from the receiving FI computer; and
transmit the Post-PT message to at least one of the issuer computer and the OI computer.

16. The system of claim 15, wherein the Post-PT message comprises at least one of a posting time, a posting amount of the funds transfer to the recipient account, and status check data concerning previous processed transaction(s) between the sender and the recipient.

17. The system of claim 11, wherein the Pre-PT message comprises at least two of the sender's full name, sender account credentials, the sender's residence address, the recipient's full name, a Government identifier (ID), passport data, cardholder billing currency, and a posting amount that will be posted to the recipient account.

18. The system of claim 11, wherein the sender is in a first country and the recipient is in one of the same country or a foreign country.

19. The system of claim 18, wherein the funding request message is a cross-border funding request message comprising cardholder identification data and a cross-border transaction amount.

20. The system of claim 11, wherein the funding request message further comprises cardholder identification data.
